(19) United States
(12) Patent Application Publication
(10) Pub. No.: US 2017/0169518 A1
(43) Pub. Date: Jun. 15, 2017

(54) SYSTEM AND METHOD FOR AUTOMATICALLY TAGGING ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/390,068

(22) Filed: Dec. 23, 2016

Related U.S. Application Data
(63) Continuation-in-part of application No. 15/361,934, filed on Nov. 28, 2016.
(60) Provisional application No. 62/295,161, filed on Feb. 15, 2016.
(60) Provisional application No. 62/260,553, filed on Nov. 29, 2015.
(60) Provisional application No. 62/261,355, filed on Dec. 1, 2015.

(51) Int. Cl. G06Q 40/00; G06F 17/30

(52) U.S. Cl. CPC G06Q 40/123; G06F 17/30011; G06F 17/30722

(57) ABSTRACT

A system and method for automatically tagging an electronic document. The method includes analyzing the electronic document to determine at least one transaction parameter; creating a template for the transaction, wherein the template is a structured dataset including the determined at least one transaction parameter; generating, based on the created template, at least one signature; and determining, based on the generated at least one signature, at least one tag for the electronic document.

### CROSS-REFERENCE TO RELATED APPLICATIONS

This application claims the benefit of U.S. Provisional Patent Application No. 62/295,161 filed on Feb. 15, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents the above-referenced applications are hereby incorporated by reference.

### TECHNICAL FIELD

The present disclosure relates generally to organizing data, and more particularly to tagging electronic documents.

### BACKGROUND

As businesses increasingly rely on technology to manage data related to operations, suitable systems for properly managing data have become crucial to success. Particularly for large businesses, the amount of data utilized daily by businesses can be overwhelming. Accordingly, manual review of such data is impractical, at best. In addition to normal sales data, businesses in countries where value-added taxes (VATs) are applied collect and utilize even more data, thereby raising additional potential points of failure.

The large number of invoices generated by typical enterprises ultimately results in creation of a multitude of electronic documents corresponding to those invoices. Existing solutions for organizing data related to such invoices typically require that each invoice is contained in a separate electronic document, thereby requiring individual scanning or otherwise capturing of each invoice. Further, to subsequently identify particular information in the electronic documents, the electronic documents typically must be either manually reviewed (e.g., by individually viewing each electronic document) or by relying on manually determined organizational schemes (e.g., using tags or groupings of electronic documents provided by a user). Such manual review is labor intensive, may waste computing resources, and increase the likelihood of human error.

In particular, some existing solutions for tagging electronic documents rely on users to manually review and tag electronic documents. For example, such a solution may require a user to view an image file showing a scan of an invoice and to provide tags related to the content therein. Such manual provision of tags may result in inaccurate tags or missed taggable content (e.g., a user may only think to tag the buyer and seller in a transaction, while the price, taxes paid, and location of sale may also be useful to tag). Other solutions present automatic tagging capabilities. However, these other solutions often face challenges in accurately tagging unstructured data and, in particular, images. Accordingly, such automatic tagging solutions may also result in inaccurate and incomplete sets of tags.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for automatically tagging an electronic document. The method comprises: analyzing the electronic document to determine at least one transaction parameter; creating a template for the transaction, wherein the template is a structured dataset including the determined at least one transaction parameter; generating, based on the created template, at least one signature; and determining, based on the generated at least one signature, at least one tag for the electronic document.

Certain embodiments disclosed herein also include a non-transitory computer readable medium having stored thereon instructions for causing a processing circuitry to perform a process, the process comprising: analyzing an electronic document to determine at least one transaction parameter; creating a template for the transaction, wherein the template is a structured dataset including the determined at least one transaction parameter; generating, based on the created template, at least one signature; and determining, based on the generated at least one signature, at least one tag for the electronic document.

Certain embodiments disclosed herein also include a system for automatically tagging an electronic document. The system comprises: a processing circuitry; and a memory, the memory containing instructions that, when executed by the processing circuitry, configure the system to: analyze the electronic document to determine at least one transaction parameter; create a template for the transaction, wherein the template is a structured dataset including the determined at least one transaction parameter; generate, based on the created template, at least one signature; and determine, based on the generated at least one signature, at least one tag for the electronic document.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for validating data according to an embodiment.

FIG. 4 is a flowchart illustrating a method for creating a dataset based on at least one electronic document according to an embodiment.

FIG. 5 is a flowchart illustrating a method for generating signatures based on electronic documents according to an embodiment.

FIG. 6 is a flowchart illustrating a method for providing tagged electronic documents based on a search query according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for automatically tagging electronic documents. In an embodiment, at least one signature is generated for at least one electronic document. Generating the signature includes analyzing, via machine imaging, the electronic document and generating, based on the analysis, at least one template including structured data, where the at least one signature is generated based on the at least one template. At least one tag is generated based on the generated at least one signature.

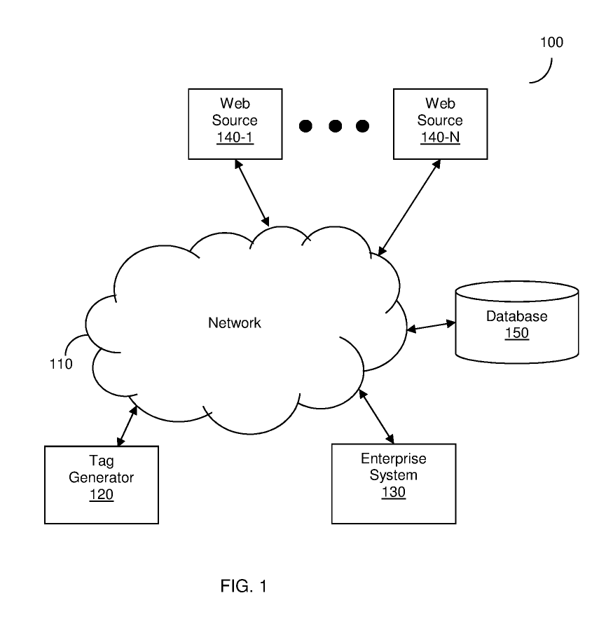

FIG. 1 shows an example network diagram 100 utilized to describe the various disclosed embodiments. In the example network diagram 100, a tag generator 120, an enterprise system 130, a plurality of web sources 140-1 through 140-N (hereinafter referred to individually as a web source 140 and collectively as web sources 140, merely for simplicity purposes), and a database 150 are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

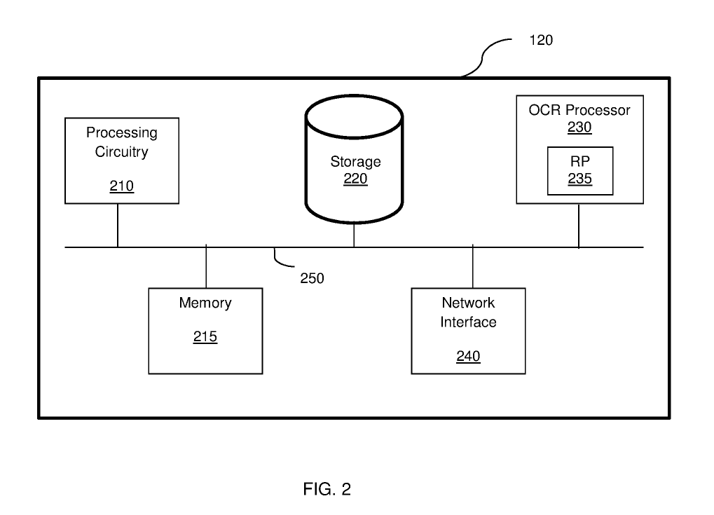

The tag generator 120 may include or be communicatively connected to a recognition processor (e.g., the recognition processor 235, FIG. 2). The recognition processor is configured to perform machine imaging. The recognition processor may include, but is not limited to, an optical character recognition engine, an image recognition engine, or both. The tag generator 120 may be configured to receive requests from the enterprise system 130 to store electronic documents illustrating information related to, e.g., payments made by an enterprise associated with the enterprise system 130, in the database 150. The request may include one or more electronic documents to be stored in the database 150, may identify one or more electronic documents to be stored in the database 150 that is accessible via the web sources 140, or both.

The database 150 stores at least electronic documents related to purchases made by the enterprise. Data included in each electronic document may be structured, semi-structured, unstructured, or a combination thereof. The structured or semi-structured data may be in a format that is not recognized by the tag generator 120 and, therefore, may be treated like unstructured data. Each electronic document may be but is not limited to, an image (e.g., an image showing a scan of a physical document), a text file, a spreadsheet, and the like. Each electronic document may represent, e.g., an invoice, a tax receipt, a flight ticket, a purchase number record, and the like.

In an embodiment, the tag generator 120 is configured to determine, for each electronic document included or identified in the request, at least one tag, and to store each electronic document and its corresponding at least one tag in the database 150. The tags may be stored as, e.g., metadata of the respective electronic documents. The database 150 may therefore act as a searchable database of electronic documents. Specifically, the database 150 including electronic documents and corresponding tags may be searched through using the tags and at least one query. The search returns at least one electronic document including information that may be relevant to the query.

Various examples for uses of the searchable database 150 follow. As a non-limiting example, an employee of an enterprise may search using the query “Israel” to find invoices and other electronic documents related to purchases made in Israel. As another non-limiting example, the employee may search using the query “VAT” to find receipts and other electronic documents related to transactions in which value-added taxes (VATs) were paid. As yet another non-limiting example, the employee may search using the query “hotel Italy” to find transactions related to purchases of hotel rooms in Italy.

In an embodiment, the tag generator 120 is configured to create datasets based on electronic documents including data at least partially lacking a known structure (e.g., unstructured data, semi-structured data, or structured data having an unknown structure). To this end, the tag generator 120 is further configured to utilize optical character recognition (OCR) or other image processing to determine data in the electronic documents.

In an embodiment, the tag generator 120 is configured to analyze the created datasets to identify transaction parameters related to transactions indicated by the electronic documents. The transaction parameters may include, but are not limited to, at least one entity identifier (e.g., a consumer enterprise identifier, a merchant enterprise identifier, or both), information related to the transaction (e.g., a date, a time, a price, a type of good or service sold, etc.), or both.

In a further embodiment, the tag generator 120 may be configured to identify the transaction parameters based on a predetermined set of contextual indicators. The contextual indicators may include, but are not limited to, a buyer (e.g., a person who entered into the transaction), a seller, a type of payment, date, goods or services purchase, and the like.

In an embodiment, the tag generator 120 is configured to create at least one template based on the created datasets. Each template is a structured dataset including at least a portion of the identified transaction parameters. In an embodiment, a template may be created for each electronic document to be tagged. In another embodiment, the tag generator 120 is configured to apply, in real-time, at least one rule to each created template to determine if requirements for tag generation are met.

In an embodiment, for each created template, the tag generator 120 is configured to generate a signature. In a further embodiment, the generated signature is a compact or otherwise condensed representation of the transaction parameters that may be efficiently processed by a computer. For example, for a transaction parameter “Jane Doe”, a condensed representation of the transaction parameter used as a portion of the signature may be “0100101111”. To this end, in yet a further embodiment, the generated signature may be a numerical value representing the transaction parameters indicated by an electronic document. For example, the signature may be or may include a binary number (e.g., 101100101000), wherein portions of the signature (e.g., 1011, 0010, and 1000) may represent different transaction parameters or portions thereof. It should be noted that the signature is discussed as being a binary value merely for simplicity purposes and without limitation on the disclosed embodiments. Other representations (such as. but not limited to, numbers expressed in decimal form, letters, symbols, and combinations thereof,) may be equally utilized without departing from the scope of the disclosure.

In an embodiment, for each electronic document, at least one tag is determined based on the signature generated for the electronic document. In a further embodiment, determining the at least one tag may include comparing the signature to a plurality of tag indices. Each tag index corresponds to a predetermined tag and may be, but is not limited to, a numerical value (e.g., a binary or decimal number), a series of letters, a series of symbols, a combination thereof, and the like. As a non-limiting example, the tag index “01234” may correspond to the tag “purchase made in Germany”. In yet a further embodiment, each determined tag is associated with a tag index matching at least a portion of the signature above a predetermined threshold. Determining tags based on the generated signatures allows for accurate automatic tagging of electronic documents based on automatic recognition of data contained therein.

In an embodiment, the comparison may include, but is not limited to, creating a map signature vector representation into vector space and using Euclidean distance as the first approximation. Creation of the signature vector representation may further include using at least one dimension reduction algorithm for reducing the number of dimensions in the vector space. In another embodiment, the comparison may include using a plurality of signature comparison techniques. The signature comparison techniques may include any techniques, either now know or hereinafter developed, that allow for comparison of signatures.

It should be noted that the embodiments described herein above with respect to FIG. 1 are described with respect to one consumer enterprise system 130 and one merchant enterprise system 150 merely for simplicity purposes and without limitation on the disclosed embodiments. Multiple consumer enterprise systems, multiple merchant enterprise systems, or both, may be equally utilized without departing from the scope of the disclosure.

FIG. 2 is an example schematic diagram of the tag generator 120 according to an embodiment. The tag generator 120 includes a processing circuitry 410 coupled to a memory 215, a storage 220, an optical character recognition (OCR) processor 230, and a network interface 240. In another embodiment, the components of the tag generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform tag generation as described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a template used for tagging electronic documents.

The network interface 240 allows the tag generator 120 to communicate with the enterprise system 130, the web sources 140, the database 150, or a combination of, for the purpose of, for example, receiving or retrieving electronic documents, storing electronic documents and corresponding tags, and the like.

It should be understood that the embodiments described herein are not limited to the specific architecture illustrated in FIG. 2, and other architectures may be equally used without departing from the scope of the disclosed embodiments.

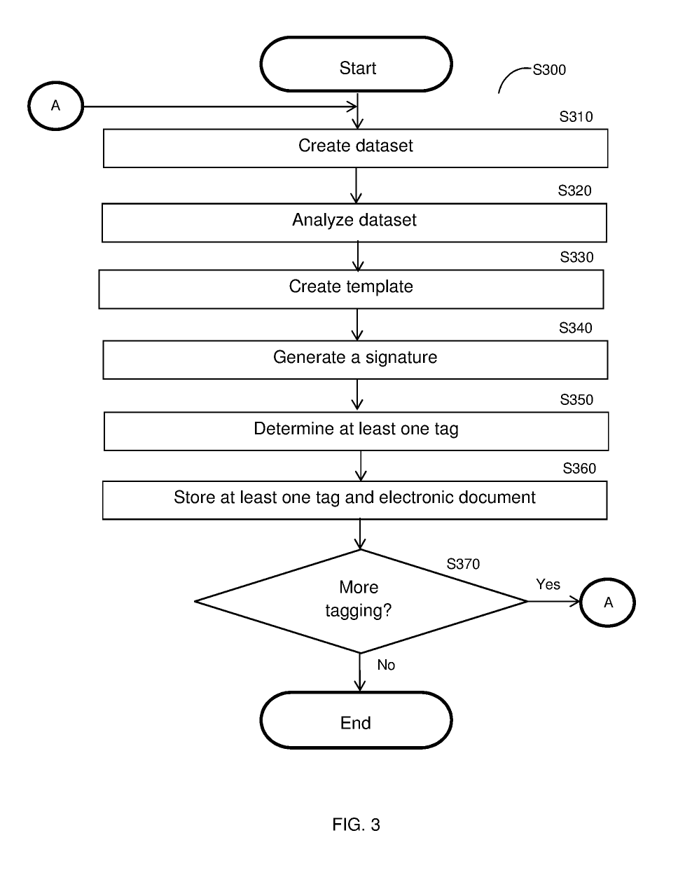

FIG. 3 is an example flowchart 300 illustrating a method for automatically tagging electronic documents according to an embodiment. In an embodiment, the method may be performed by a tag generator (e.g., the tag generator 120). In another embodiment, the method may be performed when a request to tag an electronic document is received. The request may include, but is not limited to, the electronic document or an identifier for obtaining the electronic document from, e.g., a web source.

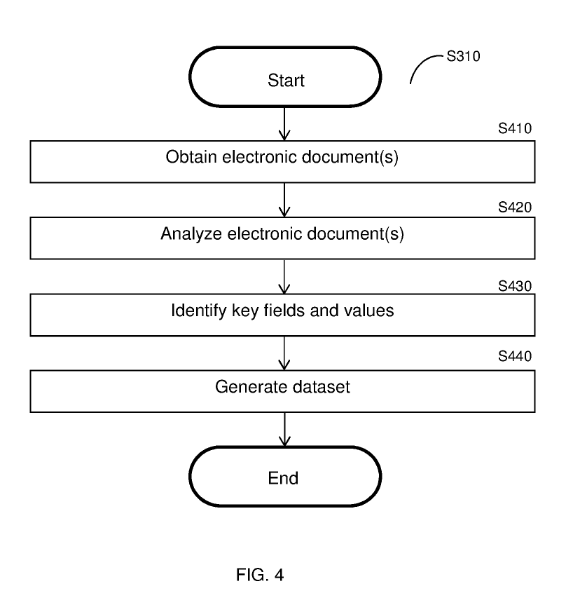

At S310, a dataset is created based on the electronic document including information related to a transaction. The electronic document may include, but is not limited to, unstructured data, semi-structured data, structured data with structure that is unanticipated or unannounced, or a combination thereof. In an embodiment, S310 may further include analyzing the electronic document using optical character recognition (OCR) to determine data in the electronic document, identifying key fields in the data, identifying values in the data, or a combination thereof. Creating datasets based on electronic documents is described further herein below with respect to FIG. 4.

In an embodiment, the dataset may be created based further on relative locations of transaction parameters with respect to, e.g., boundaries of the electronic document. In a further embodiment, the creation may be based on at least one location rule for identifying transaction parameters. The location rules may indicate expected locations of particular transaction parameters within an electronic document (e.g., merchant name at the top, total purchase amount in the bottom right, etc.).

At S320, the created dataset is analyzed. In an embodiment, analyzing the dataset may include, but is not limited to, determining transaction parameters such as, but not limited to, entity identifiers (e.g., a consumer enterprise identifier, a merchant enterprise identifier, or both), information related to the transaction (e.g., a date, a time, a price, a type of good or service sold, etc.), or both. In a further embodiment, analyzing the dataset may also include identifying the transaction based on the dataset.

At S330, a template is created for the electronic document. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, based on the created template, a signature is generated. In an embodiment, the generated signature is a numerical value representing the transaction parameters indicated by an electronic document as described further herein above with respect to FIG. 1. The signature may be or may include a binary value (e.g., 10100111), a decimal value (e.g., 123456789), a series of letters (e.g., asdfghjkl), a series of symbols (e.g., θμ\ddot{∪}Δγ), a combination thereof, and the like. The signature includes a plurality of portions, where each portion may represent a transaction parameter. In a further embodiment, the signature may be a binary value representing the transaction parameters.

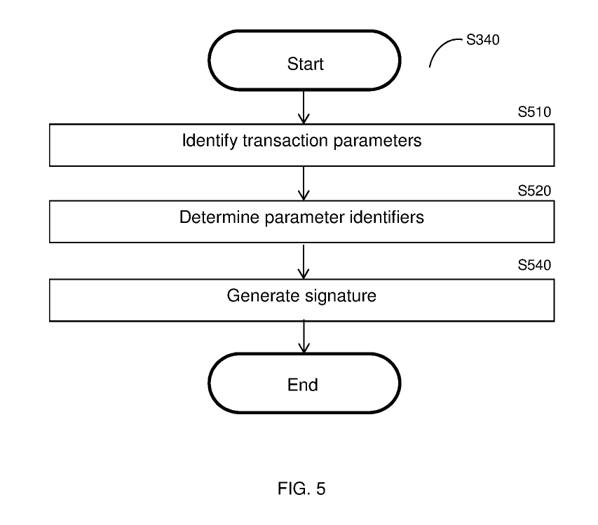

In an embodiment, generating the signature may include matching the transaction parameters to a plurality of predetermined parameters corresponding to parameter identifiers. The parameters and corresponding parameter identifiers may be stored in a parameter index. In a further embodiment, the matching may be further based on the structure of the template. As a non-limiting example, a transaction parameter “$100.00 US” in a field “total price” may be matched to parameters stored in a parameter index or a portion of a parameter index associated with price values. In yet a further embodiment, the matching may be based on a predetermined threshold. In another embodiment, the signature may be a concatenation of the parameter identifiers corresponding to the matched parameters. Signature generation based on templates is described further herein below with respect to FIG. 5.

At S350, based on the generated signature, at least one tag is determined.

Determining the at least one tag may include comparing the generated signature to a plurality of tag indices corresponding to predetermined tags. Specifically, in an embodiment, each predetermined tag corresponding to a tag index matching at least a portion of the generated signature is determined for the electronic document. Comparing signatures to tag indices is described further herein above with respect to FIG. 1.

At S360, the determined at least one tag and the electronic document are stored in a database. The tags may be stored as, e.g., metadata for the electronic document.

At S370, it is determined if additional electronic documents should be tagged and, if so, execution continues with S310; otherwise, execution terminates. It should be noted that additional electronic documents may be tagged in parallel without departing from the scope of the disclosed embodiments.

As a non-limiting example, a request providing an identifier for a scanned invoice image file is received. The scanned invoice illustrates information related to a purchase of a painting by an employee “John Smith” for which value-added taxes were paid. The scanned invoice is analyzed using machine imaging to determine unstructured data in the invoice and, in particular, to identify key fields and values in the determined unstructured data. A dataset is created. The created dataset is analyzed to determine transaction parameters indicated in the invoice. A template including the determined transaction parameters is created. A signature “001000110” is generated for the created template. The generated signature is compared to a plurality of tag indices associated with predetermined tags to identify matching tags. The matching tags include “employee John Smith”, “painting”, and “VAT transaction”. The image file containing the scanned invoice is stored with the matching tags.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database). The electronic document may be retrieved from, e.g., a web source, based on at least one identifier included in a request to tag the electronic document.

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed.

For example, if the merchant name can be identified but its address is missing, then the key field for the merchant address is incomplete. An attempt to complete the missing key filed values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

FIG. 5 is an example flowchart S340 illustrating a method for generating signatures for electronic documents according to an embodiment.

At S510, at least one transaction parameter indicated in an electronic document is identified. The at least one transaction parameter may be identified based on a structured dataset template including the at least one transaction parameter.

At S520, based on the identified at least one transaction parameter, at least one parameter identifier is determined. Each parameter identifier may be, but is not limited to, a numerical value corresponding to a parameter value. In an embodiment, S520 includes comparing the identified at least one transaction parameter to a plurality of predetermined parameters of at least one parameter index. In a further embodiment, each determined parameter identifier corresponds to a parameter matching one of the at least one transaction parameter above a predetermined threshold. In another embodiment, the comparison may be further based on a structure of the template including the at least one transaction parameter. For example, for a field “goods/services” in a template, parameters in a parameter index or in a portion of a parameter index associated with goods and services may be compared to each identified transaction parameter.

At S530, based on the determined at least one parameter identifier, a signature is generated. In an embodiment, the signature may be a concatenation of the parameter identifiers. For example, if the determined parameter identifiers include “0000”, “0101”, and “1000”, the generated signature may be “000001011000”. The generated signature may be utilized to efficiently identify tags associated with numerical tag identifiers via comparison to such tag identifiers. It should be noted that the example signature noted herein is a binary number merely for simplicity purposes and that other signatures may be equally utilized without departing from the scope of the disclosure. Specifically, the signature may include, instead of or in addition to binary numbers, other numbers (e.g., decimal numbers), letters, any other symbols, combinations thereof, and the like.

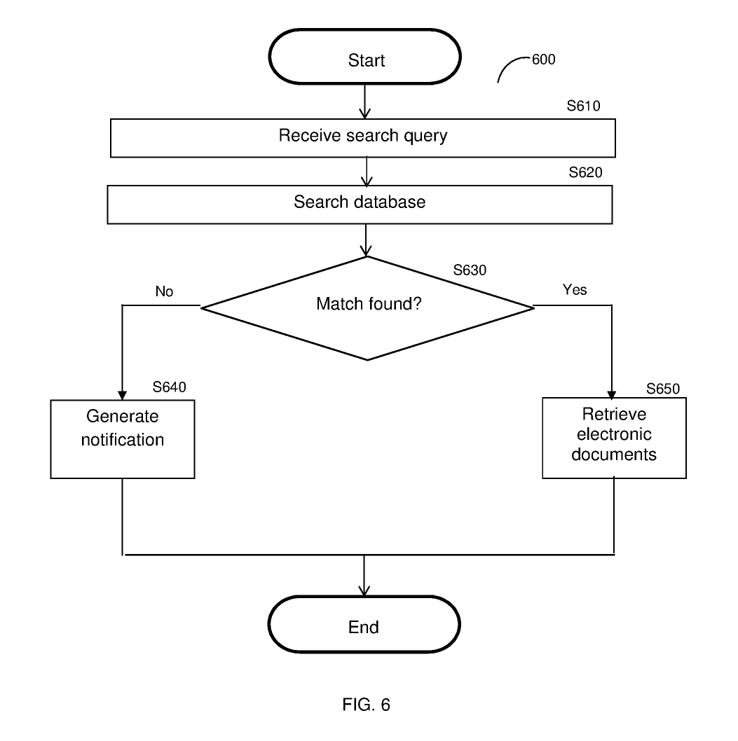

FIG. 6 is an example flowchart 600 illustrating a method for providing tagged electronic documents based on a search query according to an embodiment. In an embodiment, the method may be performed based on tags for electronic documents stored in a database (e.g., the database 140, FIG. 1).

At S610, a search query is received. The search query may be, but is not limited to, a textual query.

At S620, based on the received search query, a database storing electronic documents and associated tags is searched. In an embodiment, S620 includes determining at least one tag that matches the search query, e.g., above a predetermined threshold.

At S630, it is determined whether at least one matching tag was found and, if so, execution continues with S650; otherwise, execution continues with S640.

At optional S640, when it is determined that no matching tags were found, a notification that no electronic documents are related to the search query may be generated and sent.

At S650, when it is determined that at least one matching tag was found, at least one electronic document associated with the at least one tag is retrieved from the database. In an embodiment, S650 may further include sending the retrieved electronic document to, e.g., a user device.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatically tagging an electronic document, comprising:
analyzing the electronic document to determine at least one transaction parameter, wherein the electronic document is at least partially unstructured;
creating a template for the electronic document, wherein the template is a structured dataset including the determined at least one transaction parameter;
generating, based on the created template, a signature, wherein the signature represents the at least one transaction parameter; and
determining, based on the generated signature, at least one tag for the electronic document.

2. The method of claim 1, wherein determining the at least one transaction parameter further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the electronic document further comprises:
performing optical character recognition on the electronic document.

5. The method of claim 1, wherein determining the at least one tag further comprises:
comparing the generated signature to a plurality of tag indices associated with predetermined tags, wherein the at least one tag is determined based on the comparison.

6. The method of claim 1, wherein generating the signature further comprises:
determining, based on the created template, at least one parameter identifier, each parameter identifier representing a parameter value, wherein the generated signature includes the determined at least one parameter identifier.

7. The method of claim 6, wherein determining the at least one parameter identifier further comprises:
matching the at least one transaction parameter to a plurality of predetermined parameters, each predetermined parameter corresponding to a predetermined parameter identifier.

8. The method of claim 7, wherein the matching is based on a structure of the template.

9. The method of claim 1, further comprising:
storing the electronic document and the determined at least one tag in a database, wherein each tag is a searchable textual index term.

10. A non-transitory computer readable medium having stored thereon instructions for causing a processing circuitry to perform a process, the process comprising:
analyzing an electronic document to determine at least one transaction parameter, wherein the electronic document is at least partially unstructured;
creating a template for the electronic document, wherein the template is a structured dataset including the determined at least one transaction parameter;
generating, based on the created template, at least one signature; and
determining, based on the generated signature, at least one tag for the electronic document.

11. A system for automatically tagging an electronic document, comprising:
a processing circuitry; and
a memory, the memory containing instructions that, when executed by the processing circuitry, configure the system to:
analyze the electronic document to determine at least one transaction parameter, wherein the electronic document is at least partially unstructured;
create a template for the electronic document, wherein the template is a structured dataset including the determined at least one transaction parameter;
generate, based on the created template, at least one signature; and
determine, based on the generated signature, at least one tag for the electronic document.

12. The system of claim 11, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the electronic document.

15. The system of claim 11, wherein the system is further configured to:
compare the generated signature to a plurality of tag indices associated with predetermined tags, wherein the at least one tag is determined based on the comparison.

16. The system of claim 11, wherein the system is further configured to:
determine, based on the created template, at least one parameter identifier, each parameter identifier representing a parameter value, wherein the generated signature includes the determined at least one parameter identifier.

17. The system of claim 16, wherein the system is further configured to:
match the at least one transaction parameter to a plurality of predetermined parameters, each predetermined parameter corresponding to a predetermined parameter identifier.

18. The system of claim 17, wherein the matching is based on a structure of the template.

19. The system of claim 11, wherein the system is further configured to:
store the electronic document and the determined at least one tag in a database, wherein each tag is a searchable textual index term.
